(19) United States
(12) Patent Application Publication
(10) Pub. No.: US 2022/0066735 A1
(43) Pub. Date: Mar. 3, 2022

(54) Method for Assigning Each Ranker From Group Into Specific Group of Ranked Entities Based Upon Ranker's Preference

(71) Applicant: Scarlet Spartan Solutions, LLC, East Lansing, MI (US)

(72) Inventor: Justin Scott, East Lansing, MI (US)

(73) Assignee: Scarlet Spartan Solutions, LLC

(21) Appl. No.: 17/461,330

(22) Filed: Aug. 30, 2021

Related U.S. Application Data
(60) Provisional application No. 63/072,947, filed on Sep. 1, 2020.

(51) Int. Cl. G06F 7/36

(52) U.S. Cl. CPC G06F 7/36

(57) ABSTRACT

A unique method for determining and assigning, from a grouping of individuals or objects (“rankers”), each of these rankers into a specific entity, from a grouping of entities (“ranked entities”) having varying sized capacities (“capacities”), based upon or using each ranker's assigned preference, listed from most preferential to least preferential, to each of the ranked entities (“entry”), where the total number of rankers is equal to or less than the sum of the capacities for all the ranked entities; provided that, the numbers of rankers who prefer specific ranked entities are larger than the capacities of those specific ranked entities.

### CROSS-REFERENCE TO RELATED APPLICATION

This patent application is a non-provisional application claiming priority from U.S. Provisional Patent Application Ser. No. 63/072,947, entitled “An Algorithm To Group Rankers Into Ranked Entities Based On Every Entry In Ranked-Order Lists”, filed on Sep. 1, 2020, and is fully incorporated herein by reference.

### FIELD OF THE INVENTION

The present invention relates to a unique method for determining and assigning each ranker from a group into a specific group of ranked entities based upon the ranker's preference, where the total number of rankers does not exceed the total number of ranked entities and/or the sum of the capacities for all the ranked entities, however the numbers of rankers who prefer specific ranked entities are larger than the capacities of those specific ranked entities.

### DESCRIPTION OF THE PRIOR ART

In many formal and informal situations, there is a need for individuals or objects to be matched with one another in a way that best suits everyone or everything. An example of this would be when a group of friends is choosing each other for a “secret santa” or when a class is choosing lab partners amongst themselves. In mathematics, this type of situation has been termed the “stable marriage problem”, where an optimal solution is sought to ensure that all persons (or objects) in a group are matched with their partner in a way that maximizes the agreement between the matched pairs. This stable marriage problem can be solved using ranked-order lists from each individual or object and the Gale-Shapley algorithm. However, the Gale-Shapley algorithm is of use only if the individuals car objects are being matched as pairs to other individuals or objects within the same group; but this does not solve the problem, and a solution is needed, when there is a group of multiple individuals or objects (e.g., rankers) for a limited number of ranked entities and/or capacities.

In a non-limiting example, this type of problem, for example, would arise in the choice of schools among individuals (e.g., such as potential students). Each school may have a variable capacity that is greater than one, and the potential students will have preferences of which school they would like to attend. This problem would also, for example, arise when attempting an efficient distribution of crops to meet a societal demand within an agricultural space. Certain crops grow better in specific environments, and if the environments are limited, efficient distribution becomes an issue.

As these non-limiting examples and numerous other situations make clear is that they are outside the scope of the “stable marriage problem” and known Gale-Shapley algorithm and, therefore, there is a solution needed to solve this problem and Applicant's invention solves that problem.

### SUMMARY OF THE INVENTION

The present invention relates to a unique method for determining and assigning, from a grouping of individuals or objects (“rankers”), each of these rankers into a specific entity, from a grouping of entities (“ranked entities”) having varying sized capacities (“capacities”), based upon or using each ranker's assigned preference, listed from most preferential to least preferential, to each of the ranked entities (“entry”), where the total number of rankers is equal to or less than the sum of the capacities for all the ranked entities; provided that, the numbers of rankers who prefer specific ranked entities are larger than the capacities of those specific ranked entities.

### BRIEF DESCRIPTION OF THE DRAWINGS

The Description of the Preferred Embodiment will be better understood with reference to the following figures:

FIG. 1 is a flowchart illustrating the basic operation of Applicant's invention.

FIG. 2 is, using Applicant's invention, a diagram of the ranked entities along with the capacities of each ranked entity and the ranker's rankings for each of the ranked entities.

FIG. 3 is, using Applicant's invention, a diagram of the first criteria rating as determined for each of the ranker's and determination of the most negative first criteria rating along with the application of the assignment the most negative rankers to the most negative ranked entities. The first criteria rating is a measure of how much a ranker prefers a ranked entity relative to the rest of the group of rankers i.e. more negative is more preferential relative to the group of rankers). Thus, assigning the rankers to the entities corresponding to the most negative first criteria ratings ensures the assignment of the rankers maximize benefit to the group of rankers as a whole.

FIG. 4 is, using Applicant's invention, a diagram of the updated first criteria rating as determined for each of the ranker's and determination of the most negative first criteria rating along with the application of the assignment the most negative rankers to the most negative ranked entities.

FIG. 5 is, using Applicant's invention, a diagram of the updated first criteria rating as determined for each of the ranker's and determination of the most negative first criteria rating along with the application of the assignment the most negative rankers to the most negative ranked entities.

FIG. 6 is, using Applicant's invention, a diagram of the updated first criteria rating as determined for each of the ranker's and determination of the most negative first criteria rating along with the determination(s) of the first (second, third, fourth, fifth, etc. . . . ) most negative first criteria rating for each ranker, as well as the determination of the second (third, fourth, etc. . . . ) criteria ratings, and further application of the assignment(s) of the most negative rankers to the most negative ranked entities. The second, third, fourth, etc. criteria ratings, or “alternative” criteria ratings, are used in cases where the number of rankers who prefer a ranked entity exceeds the capacity of that specific ranked entity. In such a case, the alternative criteria ratings are used to determine cost to group of rankers should a specific ranker not be assigned to their preferred ranked entity. By assigning rankers with the most negative alternative criteria rating to their preferred ranked entity, cost to the group of rankers of not assigning a specific ranker their preferred ranked entity is minimized.

FIG. 7 is, using Applicant's invention, a diagram of the updated first criteria rating as determined for each of the ranker's and determination of the most negative criteria rating along with and further application of the assignment(s) of the most negative rankers to the most negative ranked entities.

FIG. 8 is, using Applicant's invention, a diagram of and final application of the assignment(s) of the remaining to the ranked entities.

FIG. 9 is, after using Applicant's invention, a diagram of the results, and more specifically, the final assignments for each ranker and the indication of the entry for each ranker representing the order of preference that all of the rankers received from their entry.

### DETAILED DESCRIPTION OF THE PREFERRED EMBODIMENT

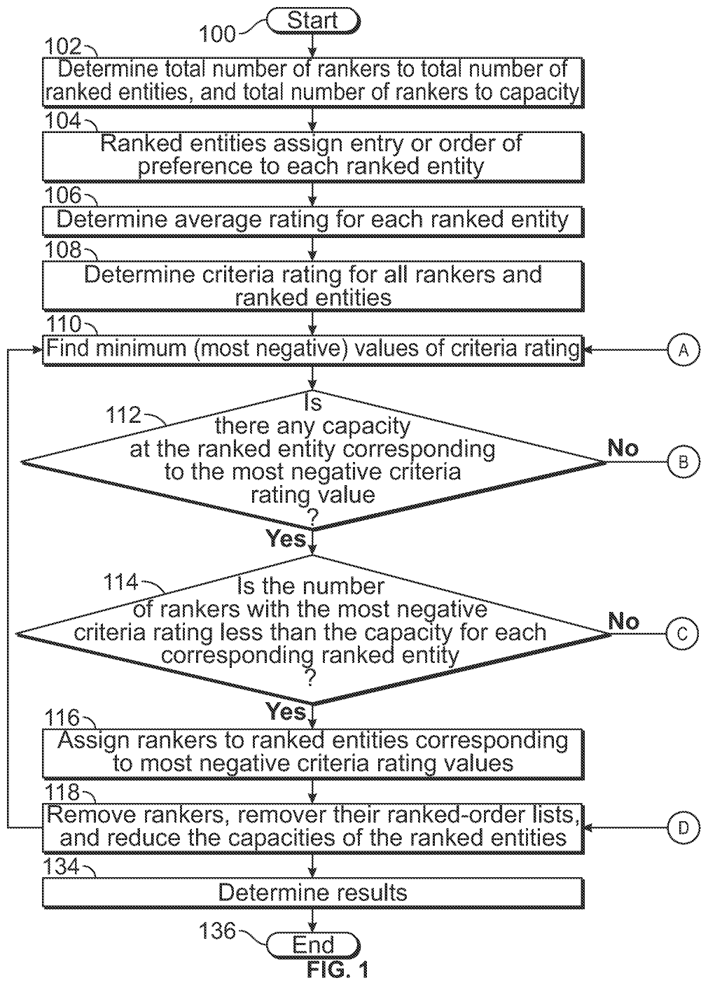

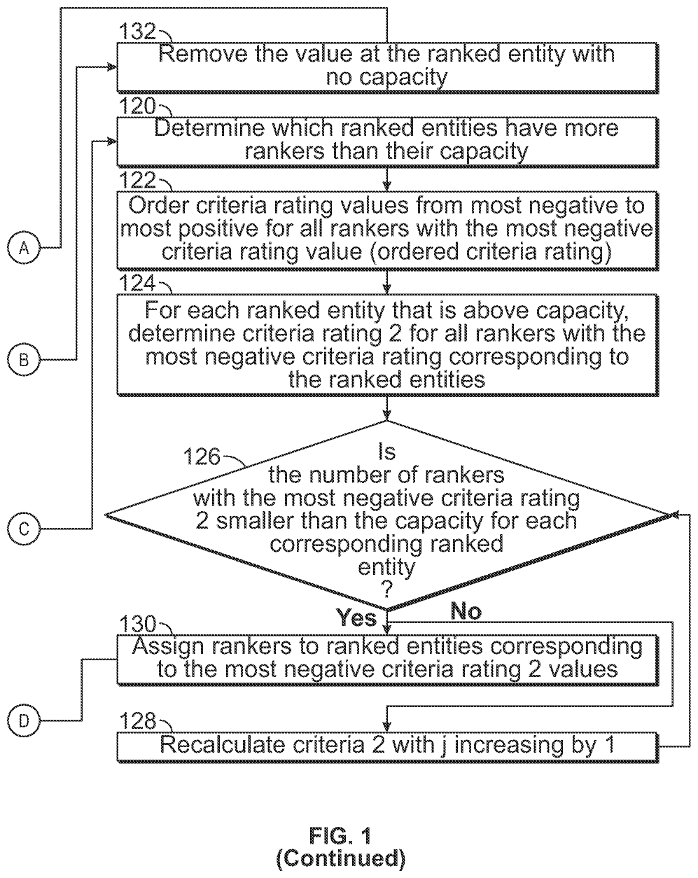

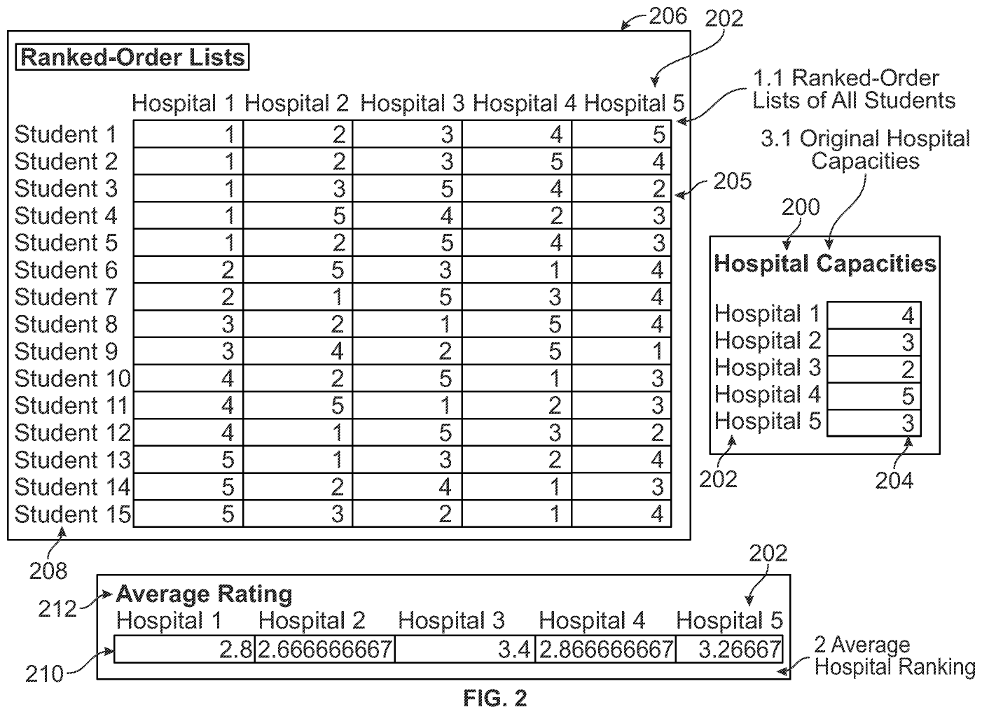

Turning to FIG. 1 is an overview of the operation of Applicant's invention as shown as a process or series of steps, with each of these steps as further illustrated and referenced in more detail through the non-limiting example as set forth in FIGS. 2 through 9.

The process or series of steps of Applicant's invention begins with Step 100. If the Applicant's invention is to be used, proceed to Step 102. if Applicant's invention is not to be used or begin, proceed to Step 136, and the process is stopped.

In Step 102, if the total number of rankers for each grouping of individuals or objects is less than or equal to the total number of ranked entities from the grouping of entities and/or the total number of rankers for each grouping of individuals or objects is less than or equal to the total capacity for each of the ranked entities from the grouping of entities, proceed to Step 104. If not, proceed back to Step 100.

In Step 104, each of the rankers assigns an entry that represents an order of preference to each of the ranked entities. In the preferred embodiment, the entity, or order of preference is listed from the ranker's most preferential entity, and assigned a numerical number 1, to the ranker's next least most preferential entity, and assigned a numerical number 2, and so on, with each subsequent ranked entity being assigned an entry or order of preference of numerical number that is sequential number order (e.g., 3, 4, etc . . . ), as illustrated in FIG. 2.

In FIG. 2, the problem to be solved is similar to those described above—that there are many potential students that are desirous of their preferred hospitals; but that, there is a limited choice of hospitals and the capacity amongst the hospitals is likewise limited.

Proceeding with Applicant's invention, as shown in box 200, the ranked entities 202 in this non-limiting example are “hospitals” or “Hospitals.” As illustrated, there are 5 hospitals and the total capacities 204 for each of the ranked entities 202 (e.g., hospitals) are provided.

As shown in box 206, the ranker's rankings or entries 205 for each of the ranked entities 202 are provided. As illustrated, the rankers 208 are students and the total number of students is 15 with each of the ranked entities 202 (e.g., 5 hospitals) all assigned an entry 205 that represents an order of preference from each of the rankers 208 (e.g., which in this non-limiting example is an entry number of 1 through 5). Once completed, proceed to Step 106.

In Step 106, based on the ranker's rankings or entry 205 and order of preference that was assigned to each of the ranked entities 202 by the rankers 208, an average rating 212 is determined for each ranked entity 202, as illustrated in FIG. 2, and as shown by box 210. Throughout this disclosure, anywhere “determined” is referenced may also be referred to as “created.”

In FIG. 2. as shown in box 210, the average rating 212 is shown for each ranked entity 202. In the preferred embodiment, the average rating 212 is determined by totaling all of the entries 205 for each hospital from each of the rankers 208 and dividing this total by the total number of rankers 208. For example, in this non-limiting example for hospital 1, the average rating 212 is 2.8 (e.g., adding all of the entries 205 from Student 1 through 15 for Hospital 1 totals 43. Then, dividing this total 43 by the total number of Students of 15 results in an average rating of 2.8). Once completed, proceed to Step 108.

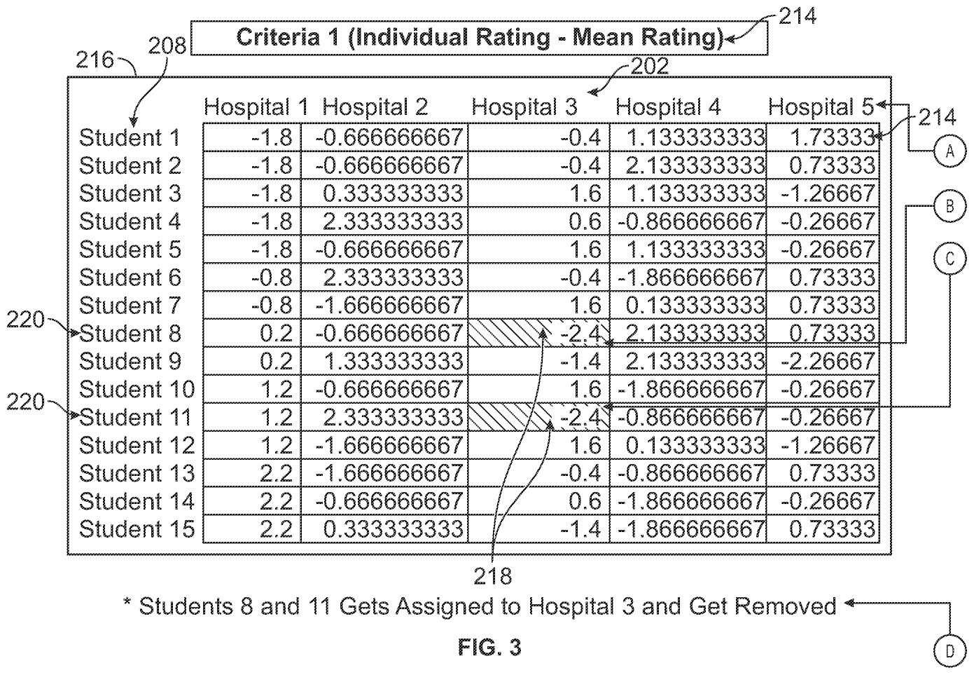

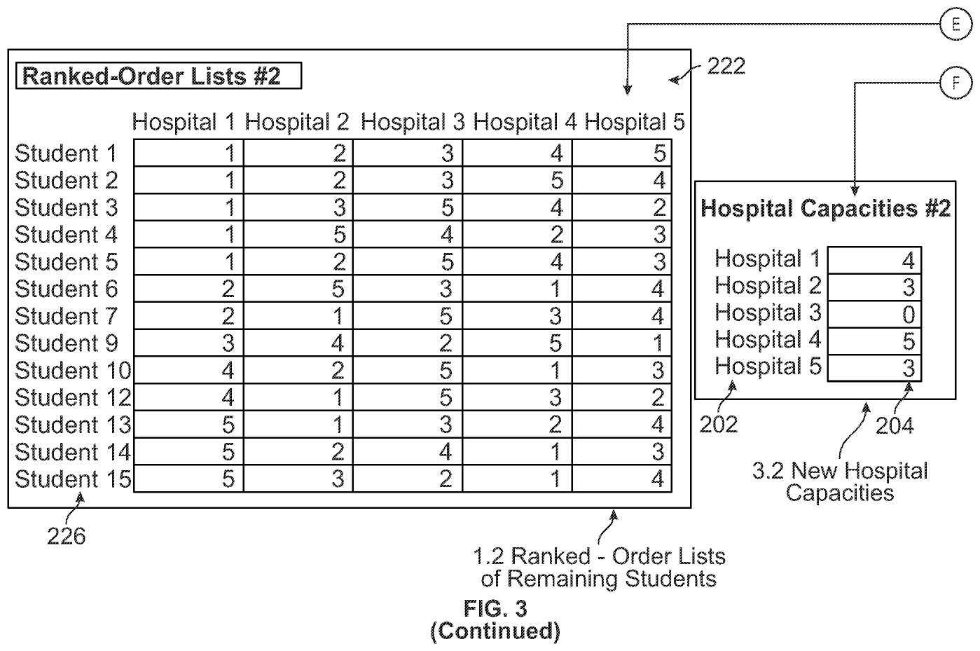

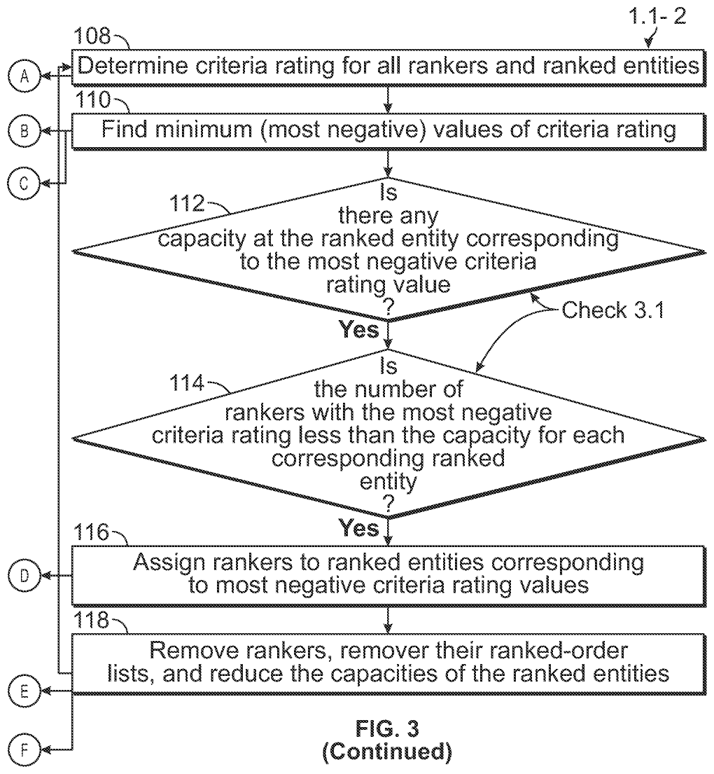

In Step 108, based on the entry 205 and order of preference that was assigned to each of the ranked entities 202 by the rankers 208 and the average rating 212, a first criteria rating 214 is determined for each ranked entity 202 associated with each ranker 208, as illustrated in FIG. 3. In the preferred embodiment, the first criteria rating 214 is determined by subtracting the average rating 212 from the entry 205 and order of preference that was assigned to each of the ranked entities 202 by the rankers 208. In this manner, each ranked entity 202 is provided with a first criteria rating 214 associated with each ranker 208. For example, in this non-limiting example for hospital 1, as shown in box 216, the first criteria rating 214 is “−1.8” (e.g., subtracting the average rating 212 of “2.8” for Hospital 1 from the entry 205 of “1” from Student 1 results in a first criteria rating of −1.8). Once completed, proceed to Step 110.

In Step 110, determine or find the most negative first criteria rating 214 associated for any ranker 208 with any ranked entity 202. As illustrated in FIG. 3, and as shown in box 216 of all the first criteria ratings 214 associated with any ranked entity 202 for all of the rankers 208, the most negative first criteria rating 214, in this non-limiting example, is “−2.4” which is associated with rankers 208 (Student 8 and Student 11) and with ranked entity 202 (e.g., Hospital 3). Each of the rankers 208 having this most negative first criteria rating 214 are referred to as most negative rankers 220. And, each of these ranked entities 202 with the most negative first criteria rating 214 are also referred to as most negative ranked entity 218. Once completed, proceed to Step 112.

In Step 112, determine if there is any capacity 204, or remaining capacity 204, at any of the most negative ranked entities 218. Based on Step 110, and in the non-limiting example, the current most negative ranked entities 218 is “Hospital 3.” Referring back to FIG. 2, as shown in box 200, the total capacity 204, or remaining capacity 204, for this ranked entity 202 (e.g., Hospital 3) is “2”. If the determination is that there is capacity 204, or remaining capacity 204, at any of the most negative ranked entities 202, such as here with “Hospital 3” having capacity 204 of “2”, then proceed to Step 114. If the determination is that there is no (e.g., or zero) capacity 204, or remaining capacity 204, at any of the current most negative ranked entities 218, then proceed to Step 132.

In Step 114, determine if the total number of the most negative rankers 220 is equal to or less than the capacity 204, or remaining capacity 204, for each of the current most negative ranked entities 218. Based on Step 110, and in the non-limiting example, the roost negative rankers 220 is “2” (e.g., Student 8 and Student 11); and the capacity 204, or remaining capacity 204, of the most negative ranked entities 218 (e.g., “Hospital 3”) is “2”. In this manner, as the total number of the most negative rankers 220 (e.g., 2) is equal to or less than the capacity 204 (e.g., 2) for each of the most negative ranked entities 218, proceed to Step 116. If the total number of the most negative rankers 220 is greater (e.g., or not equal to or less than) the capacity 204, or remaining capacity 204, for each of the most negative ranked entities 218, proceed to Step 120.

In Step 116, assign the most negative rankers 220 to the most negative ranked entities 218. As illustrated in FIG. 3, the most negative rankers 220 (e.g., Student 8 and Student 11) are assigned to the most negative ranked entities 218 (e.g., “Hospital 3”). As the capacity 204 for “Hospital 3” was “2” and the most negative rankers 220 (e.g., Student 8 and Student 11) are assigned to “Hospital 3”, this assignment of rankers 208 then takes up the entire capacity 204 of “2” for “Hospital 3”. Once completed, proceed to Step 118.

In Step 118, with the most negative rankers 220 (e.g., Student 8 and Student 11) being assigned to the most negative ranked entities 218 (e.g., “Hospital 3”) and taking up the entire capacity 204 of “2” for “Hospital 3”, the most negative rankers 220, also referred to as “assigned rankers” and all entries 205 associated with these assigned rankers 208 (e.g., Student 8 and Student 11) are removed from the rankers list. In this manner, the assigned rankers 208 (e.g., Student 8 and Student 11) and all its or their associated entries 205 are removed from FIG. 2, box 206, as now reflected and. illustrated in FIG. 3, and as shown in the updated box 222, leaving the remaining rankers 226.

Additionally, the capacity 204 to the most negative ranked entities 218 (e.g., “Hospital 3”) is likewise updated to reflect the assigned rankers. In this manner, the capacity 204 to the most negative ranked entities 218 (e.g., “Hospital 3”) is removed from FIG. 2, box 200, as now reflected and illustrated in FIG. 3, and as shown in updated box 224 which shows the capacity 204 for “Hospital 3” as being “0”. Once completed, proceed to Step 110.

In Step 110, the process or series of Steps 110 through 118 are repeated for the remaining rankers 226.

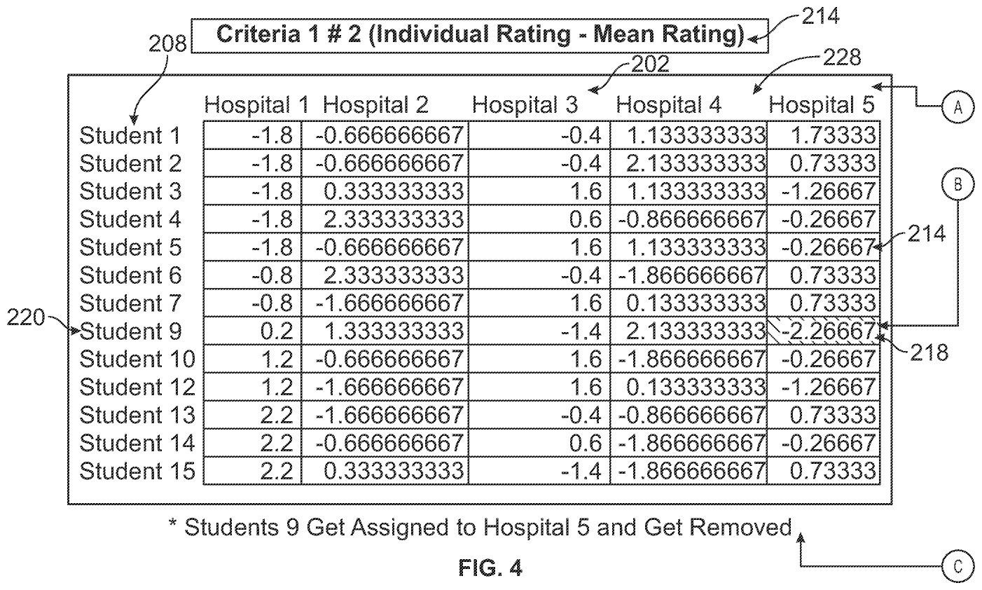

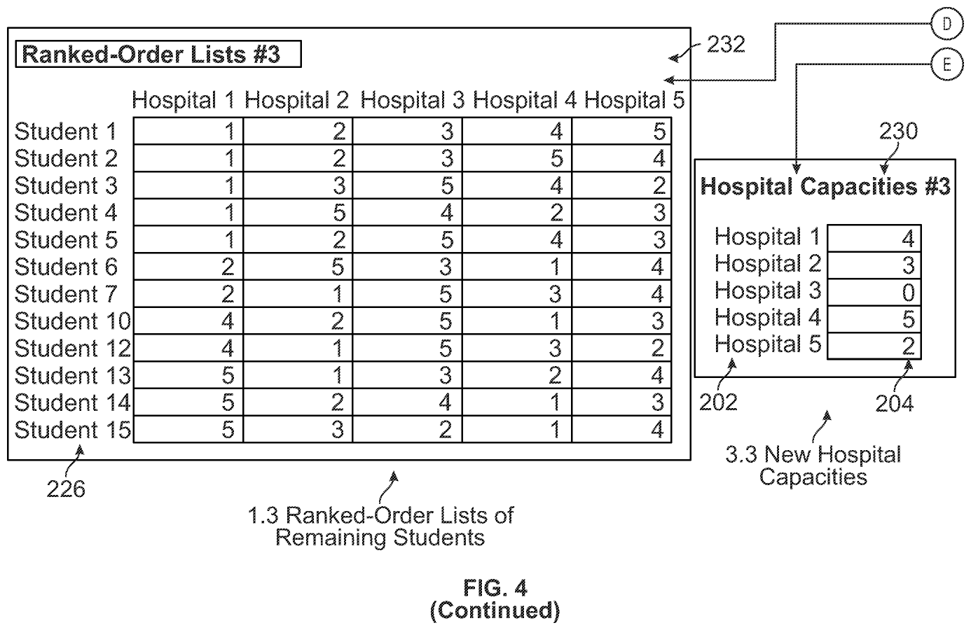

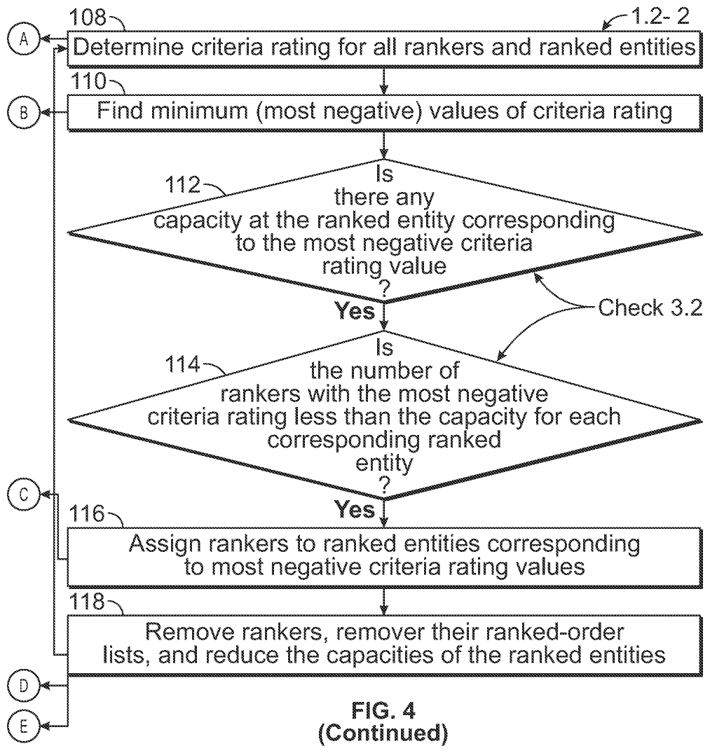

Repeating Step 110 and continuing with the non-limiting example, as illustrated in FIG. 4, and as shown in box 228, the most negative criteria rating 214 associated for any ranker 208 with any ranked entity 202, is “−2.26667” which is associated with ranker 208 (e.g., Student 9) and with ranked entity 202 (e.g., Hospital 5), the now current most negative ranked entity 218.

Repeating Step 112 and continuing with the non-limiting example, as illustrated in FIG. 4, and as shown in box 228, the now current most negative ranked entity 218 is “Hospital 5” and, as shown in box 224, the total capacity 204, or remaining capacity 204, for this ranked entity 202. (e.g., Hospital 5) is “3.”

Repeating Step 114 and continuing with the non-limiting example, as illustrated in FIG. 4, and as shown in box 228, the now current most negative ranker 220 is “1” (e.g., Student 9); and the capacity 204, or remaining capacity 204; of the current most negative ranked entity 218 (e.g., “Hospital 5”) is “3”, the total number of the current most negative rankers 220 is equal to or less than the capacity 204, or remaining capacity 204, for each of the current most negative ranked entities 218.

Repeating Step 116 and continuing with the non-limiting example, the current most negative ranker 220 (e.g., Student 9) is assigned to the most negative ranked entity 218 (e g., “Hospital 5”). As the capacity 204 for “Hospital 5” is “3” and the most negative ranker 220 (e.g., Student 9) is assigned to “Hospital 5”, this assignment of ranker 208 then takes up only 1 of the capacity 204 of “3” for “Hospital 5”. Once completed, proceed back to Step 118.

Repeating Step 118 and continuing with the non-limiting example, with the most negative ranker 220 (e.g., Student 9) being assigned to the most negative ranked entity 218 (e.g., “Hospital 5”) and taking up only 1 of the capacity 204 of “3” for “Hospital 5”, the roost negative ranker 220 or “assigned ranker” and all entries 205 associated with this assigned ranker 208 (e.g., Student 9) is removed from the rankers list. In this manner, the assigned ranker 208 (e.g., Student 9) and all its associated entries 205 are removed from FIG. 3, box 222, as now reflected and illustrated in FIG. 4, and as shown in the updated box 232, leaving the remaining rankers 226.

Additionally, the capacity 204 to the most negative ranked entities 218 (e.g., “Hospital 5”) is likewise updated to reflect the assigned rankers. In this manner, the capacity 204 to the most negative ranked entities 218 (e.g., “Hospital 5”) is removed from FIG. 3, box 224, as now reflected and illustrated in FIG. 4, and as shown in updated box 230 which shows the capacity 204 for “Hospital 5” as being “2”. Once completed, proceed back to Step 110.

In Step 110, the process or series of Steps 110 through 118 are repeated again for the remaining rankers 226.

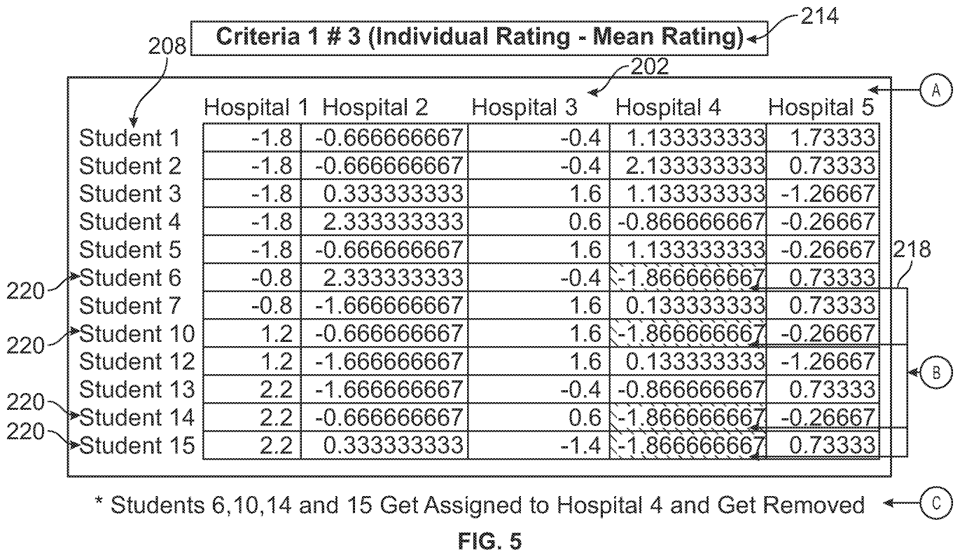

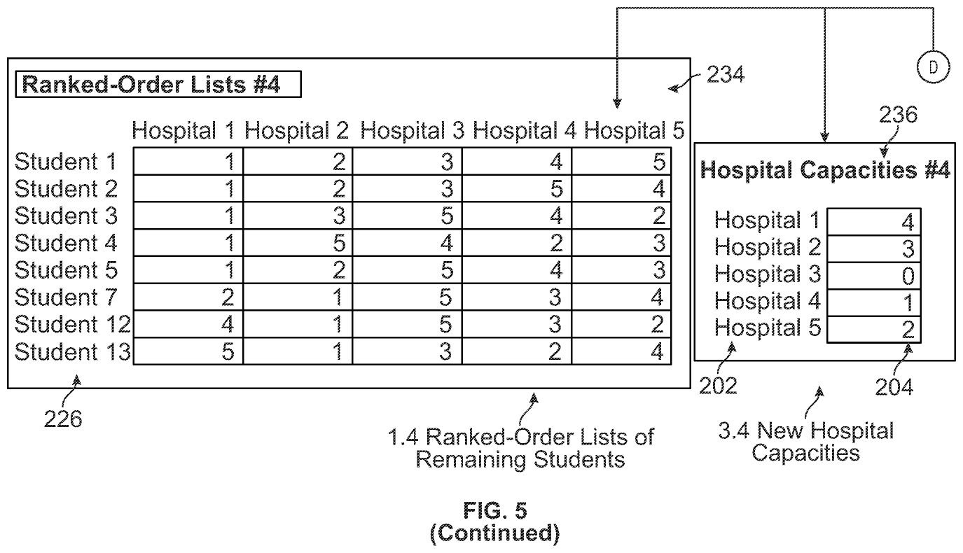

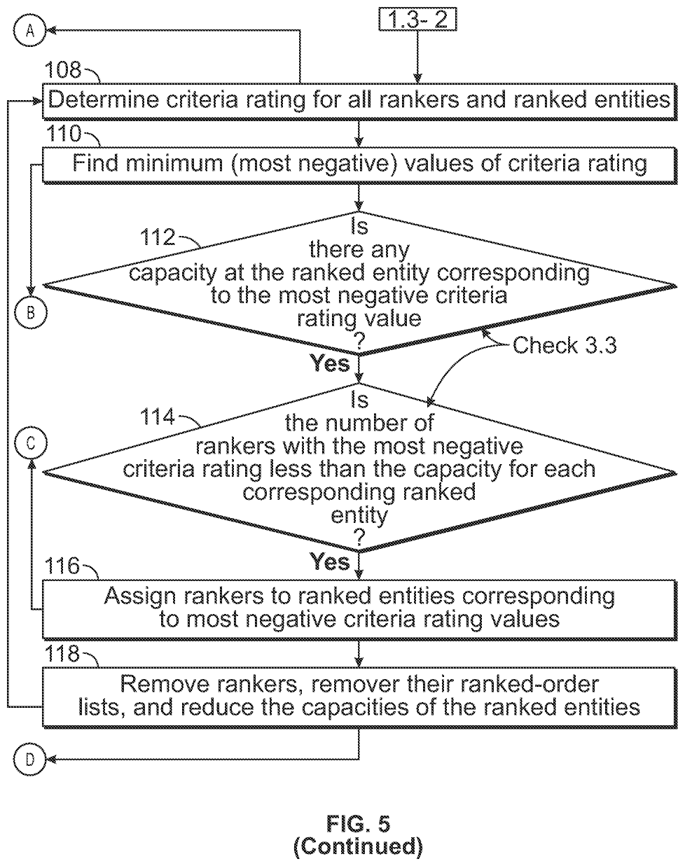

Repeating Steps 110 through 118 and continuing with the non-limiting example, the most negative rankers 220 (e.g., Students 6, 10, 14, and 15) are assigned to the most negative ranked entity 218 (e.g., “Hospital 4”) and taking up 4 of the capacity 204 of “5” for “Hospital 4”. The most negative ranker 220 or “assigned ranker” and all entries 205 associated with the assigned rankers 208 (e.g., Students 6, 10, 14, and 15) are removed from the rankers list. In this tanner, the assigned rankers 208 (e.g., Students 6, 10, 14, and 15) and all its or their associated entries 205 are removed from FIG. 4, box 232, as now reflected and illustrated in FIG. 5, and as shown in the updated box 234, leaving the remaining rankers 226,

Additionally, the capacity 204 to the most negative ranked entities 218 (e.g., “Hospital 4”) is likewise updated to reflect the assigned rankers. In this manner, the capacity 204 to the most negative ranked entities 218 (e.g., “Hospital 4”) is removed from FIG. 4, box 230, as now reflected and illustrated in FIG. 5, and as shown in updated box 236 which shows the capacity 204 for “Hospital 4” as being “1”. Once completed, proceed back to Step 110.

In Step 110, the process or series of Steps 110 through 118 are repeated again for the remaining rankers 226.

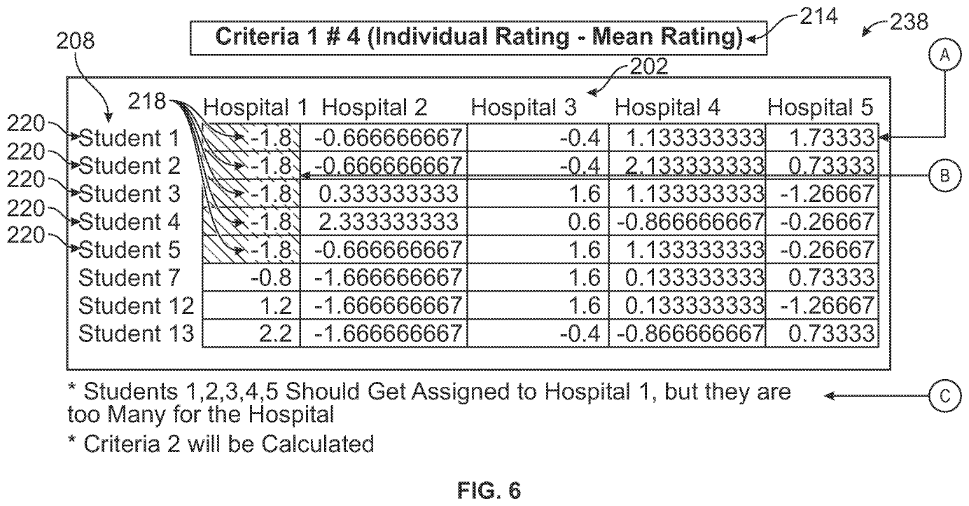

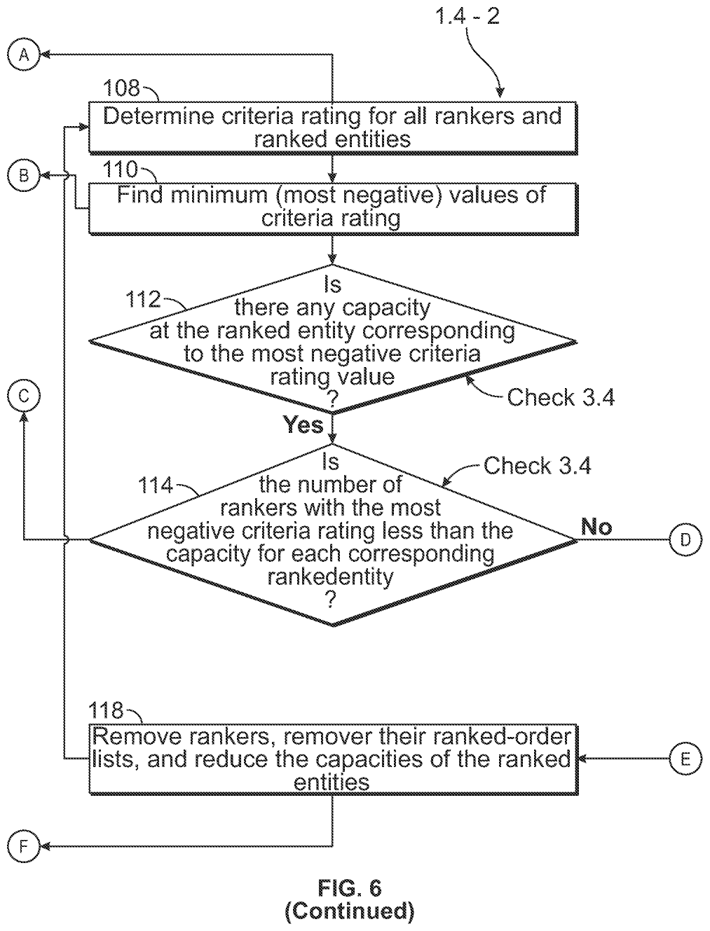

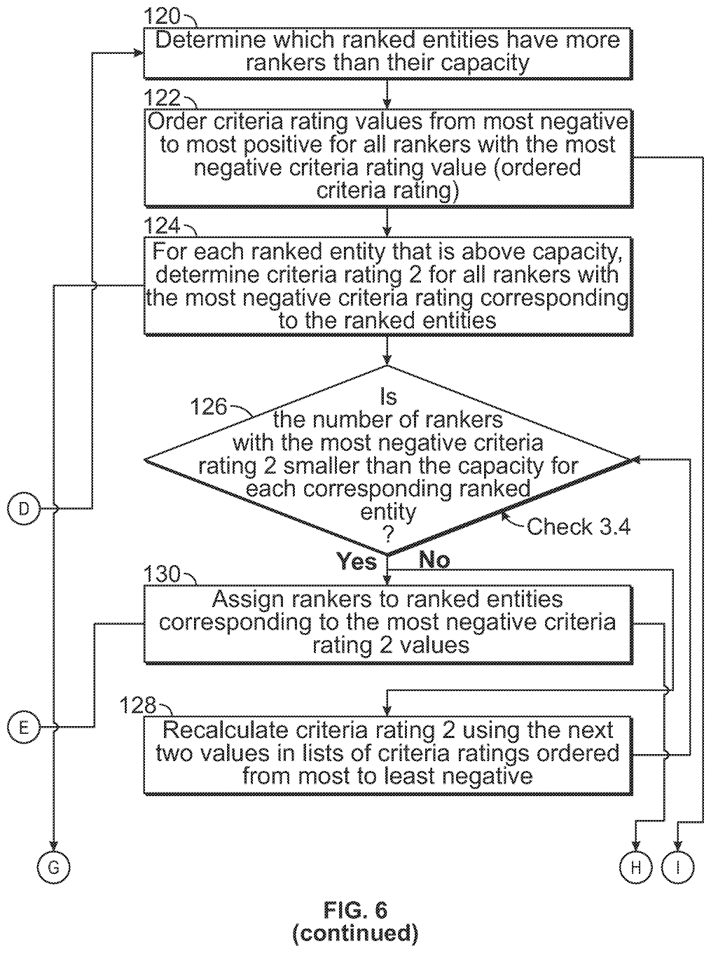

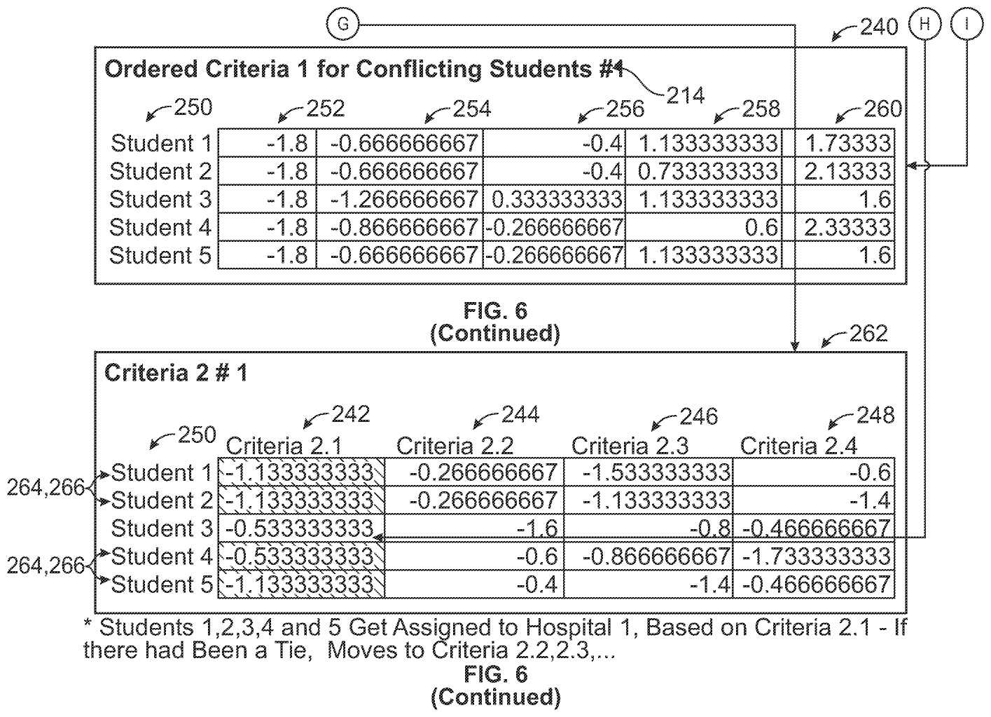

Repeating Step 110 and continuing with the non-limiting example, as illustrated in FIG. 6, and as shown in box 238, the most negative first criteria rating 214 associated for any ranker 208 with any ranked entity 202, is “−1.8” which is associated with rankers 208 (e.g., Students 1, 2, 3, 4, and 5) and with ranked entity 202 (e.g., Hospital 1), the now current most negative ranked entity 218.

Repeating Step 112 and continuing with the non-limiting example, as illustrated in FIG. 6, and as shown in box 238, the now current most negative ranked entity 218 is “Hospital 1” and, as illustrated in FIG. 5, and as shown in box 236, the total capacity 204, or remaining capacity 204, for this ranked entity 202 (e.g., Hospital 1) is “4.”

Repeating Step 114 and continuing with the non-limiting example, as illustrated in FIG. 6, and as shown in box 238, the now current most negative rankers 220 is “5” (e.g., Students 1, 2, 3, 4, and 5) and the capacity 204. or remaining capacity 204, of the current most negative ranked entity 218 (e.g., “Hospital 1”) is “4”, the total number of the current most negative rankers 220 is not equal to or less than the capacity 204, or remaining capacity 204, for each of the current most negative ranked entities 218; but rather, is greater. When this occurs, proceed to Step 120.

In Step 120, determine which of the current most negative ranked entities 218 have more current most negative rankers 220 than the capacity 204 for these current most negative ranked entities 218.

Based on previous Step 114, and in the non-limiting example, the current most negative ranked entities 218 is (e.g., “Hospital 1”) and the capacity 204 for this current most negative ranked entities 218 (e.g., “Hospital 1”) is “4”, as illustrated in FIG. 5, and as shown in box 236. And, the current most negative rankers 220 are (e.g., Students 1, 2, 3, 4, and 5) for a total of “5”. In this manner, the current most negative ranked entities 218 (e.g., “Hospital 1”) has a total of “5” current most negative rankers 220 which is greater than its capacity 204 of “4”. As a result, these current most negative rankers 220 exceeding this capacity 204 of the current most negative ranked entities 218 are referred to as “resulting most negative rankers 250”. Once completed, proceed to Step 122.

In Step 122, arrange the first criteria ratings 214 for each of the ranked entities 202 from the most negative to the most positive for all of the resulting most negative rankers 250. In the non-limiting example, the resulting most negative rankers 250 being (e.g., Students 1, 2, 3, 4, and 5), as illustrated in FIG. 6, and as shown in box 238. Applying this arrangement, as illustrated in FIG. 6, and as shown in box 240, the criteria ratings 214 for each of these resulting most negative rankers 250 being (e.g., Students 1, 2, 3, 4, and 5) are arranged showing the most negative criteria rating 214 to the most positive criteria rating 214. In this example, for one of the resulting most negative rankers 250 (e.g., Student 4), this resulted in arrangement from sequential order of (e.g., Hospital 1 through 5), as illustrated in FIG. 6, and as shown in box 238, to (e.g., Hospital 1, Hospital 4, Hospital 5, Hospital 3, and Hospital 2), as illustrated in FIG. 6, and as shown in box 240. Once completed, proceed to Step 124.

In Step 124, determine a second criteria rating 242 for each of the resulting most negative rankers 250 that is above the capacity 204 of the current most negative ranked entities 218. In the preferred embodiment, the second criteria rating 242 is determined by, for each of the resulting most negative rankers 250, subtracting the second most negative first criteria rating 254 from the first most negative first criteria rating 252, as illustrated in FIG. 6, and as shown in box 240. For each of the resulting most negative ranked entities 250, the second criteria rating 242 is provided as illustrated in FIG. 6, and as shown in box 262.

A third criteria rating 244 is determined for each of the resulting most negative rankers 250 that is above the capacity 204 of the current most negative ranked entities 218. In the preferred embodiment, the third criteria rating 244 is determined by, for each of the resulting most negative rankers 250, subtracting the third most negative first criteria rating 256 from the second most negative first criteria rating 254, as illustrated in FIG. 6, and as shown in box 240. For each of the resulting most negative ranked entities 250, the third criteria rating 244 is provided as illustrated in FIG. 6, and as shown in box 262.

A fourth criteria rating 246 is determined for each of the resulting most negative rankers 250 that is above the capacity 204 of the current most negative ranked entities 218. In the preferred embodiment, the fourth criteria rating 246 is determined by, for each of the resulting most negative rankers 250, subtracting the fourth most negative first criteria rating 258 from the third most negative first criteria rating 256, as illustrated in FIG. 6, and as shown in box 240. For each of the resulting most negative ranked entities 250, the fourth criteria rating 246 is provided as illustrated in FIG. 6, and as shown in box 262.

A fifth criteria rating 248 is determined for each of the resulting most negative rankers 250 that is above the capacity 204 of the current most negative ranked entities 218. In the preferred embodiment, the fifth criteria rating 248 is determined by, for each of the resulting most negative rankers 250, subtracting the fifth most negative first criteria rating 260 from the fourth most negative first criteria rating 258, as illustrated in FIG. 6, and as shown in box 240. For each of the resulting most negative ranked entities 250, the fifth criteria rating 248 is provided as illustrated in FIG. 6, and as shown in box 262,

Each of second criteria rating 242, third criteria rating 244, fourth criteria rating 246, and fifth criteria rating 248 for each of the resulting most negative ranked entities 250 shows the cost to the group of rankers e.g., resulting most negative ranked entities 250) if the specific ranker is not assigned to their preferred ranked entity 202. Thus, larger negative values of second criteria rating 242, third criteria rating 244, fourth criteria rating 246, and fifth criteria rating 248 indicate larger costs to the group or rankers if the specific ranker is not assigned their preferred ranked entity 202. This is why the resulting most negative ranked entities 250 with the most negative second criteria rating 242, third criteria rating 244, fourth criteria rating 246, and/or fifth criteria rating 248 are identified and assigned their preferred ranked entities, because if they were not assigned those ranked entities, it would cost the group of rankers more.

Once completed, proceed to Step 126. In Step 126, determine a second resulting most negative ranker 264 from the second criteria rating 242 and then whether the total number of the second resulting most negative rankers 264 is equal to or less than the capacity 204 for each of the corresponding ranked entities 202. As illustrated in FIG. 6, and as shown in box 262, the second resulting most negative rankers 264 having the most negative second criteria rating 242 is “−1.33333333” are (e.g. Students 1, 2, 4, and 5). Thus, the total number of second resulting most negative rankers 264 (e.g., Students 1, 2, 4, and 5) being “4”. For each of these second resulting most negative rankers 264, as illustrated in FIG. 6, and as shown in box 238, the most negative ranked entities 218 is (e.g., “Hospital 1”), as illustrated in FIG. 6, and as shown by box 238. For this ranked entity 202 (e.g., Hospital 1), as illustrated in FIG. 5, and as shown in box 236, the capacity 204 is “4”, If the determination is that the total number of second resulting most negative rankers 264 is greater than the capacity 204 of each of the corresponding ranked entities 202, then proceed to Step 128. If, as is the non-limiting example here, the result is that the total number of second resulting most negative rankers 264 of “4” is equal to or less than the capacity 204 of “4” for each of the corresponding ranked entities 202 (e.g., Hospital 1), then proceed to Step 130.

In Step 128, the process as set forth in Step 126 is repeated for the second resulting most negative ranker 264 from the third criteria rating 244 and then whether the total number of the second resulting most negative rankers 264 is equal to or less than the capacity 204 for each of the corresponding ranked entities 202. If, using the third criteria rating 244, the determination is that the total number of second resulting most negative rankers 264 is greater than the capacity 204 of each of the corresponding ranked entities 202, then proceed to Step 128, and repeat the process for the fourth criteria rating 246 (and so on) until the result is that the total number of second resulting most negative rankers 264 is equal to or less than the capacity 204 for each of the corresponding ranked entities 202, then proceed to Step 130.

In Step 130, assign the second resulting most negative rankers 264 to its corresponding most negative ranked entities 218. As illustrated in FIG. 6, and as shown by box 262, the second resulting most negative rankers 264 (e.g., e.g., Students 1, 2, 4, and 5) are assigned to their corresponding most negative ranked entities 218 (e.g., “Hospital 1”), as illustrated by FIG. 6, and as shown by box 238. As the capacity 204 for “Hospital 1” is “4”, this assignment of the second resulting most negative rankers 264 then takes up the entire capacity 204 of “4” for “Hospital 1”. Once completed, proceed back to Step 118.

Back to Step 118, with the second resulting most negative rankers 264 (e.g., Students 1, 2, 4, and 5) being assigned to the most negative ranked entities 218 (e.g., “Hospital 1”) and taking up the entire capacity 204 of “4” for “Hospital 1”, the second resulting most negative rankers 264, also referred to as “second assigned rankers” and all entries 205 associated with these second assigned rankers 266 (e.g., Students 1, 2, 4, and 5) are removed from the rankers list. In this manner, the second assigned rankers 266 (e.g., Students 1, 2, 4, and 5) and all its or their associated entries 205 are removed from FIG. 5, box 234, as now reflected and illustrated in FIG. 6, and as shown in the updated box 268, leaving the remaining rankers 226.

Additionally, the capacity 204 to the most negative ranked entities 218 (e.g., “Hospital 1”) is likewise updated to reflect the second assigned rankers. In this manner, the capacity 204 to the most negative ranked entities 218 (e.g., “Hospital 1”) is removed from FIG. 5, box 236, as now reflected and illustrated in FIG. 6, and as shown in updated box 270 which shows the capacity 204 for “Hospital 1” as being “0”. Once completed, proceed back to Step 110.

Also, by way of further illustration for this previous assignment, with respect to Student 4, Student 4 was assigned hospital 1 because there were “4” slots available in hospital 1, and they had the 4th largest most negative second criteria rating 242 (or second criteria). Even though Student 4 did not have the same most negative second criteria rating 242 as the other 3 students (e.g., Students 1, 2, and 5), Student 4 was still assigned because their assignment did not overfill the capacity 204 of “4” for “Hospital 1”. In other words, if there had been a capacity 204 of only “3” slots available for “Hospital 1”, Student 4 would not have been assigned. If Student 3 had the most negative second criteria rating 242 as Student 4 (and their most negative second criteria rating 242 values were smaller than the other students), they both would have continued on to most negative second criteria rating 244 as so on until one of them was place in the hospital.

For most negative second criteria rating 242, only the resulting most negative rankers 250 with the most negative first criteria ratings 214 get assigned. For negative second criteria rating 244 onwards, the resulting most negative rankers 250 with the largest criteria get assigned until the hospital is full because negative second criteria rating 244 is only calculated for those with the most negative first criteria ratings 214 values. Therefore, by virtue of having the lost negative first criteria ratings 214 value, even if Student 4 was not placed in Hospital 1 in the third iteration, the next iteration would have had Student 4 getting the most negative first criteria ratings 214 value and getting placed anyway. As a result, Student 4 was safely assigned to Hospital 1.

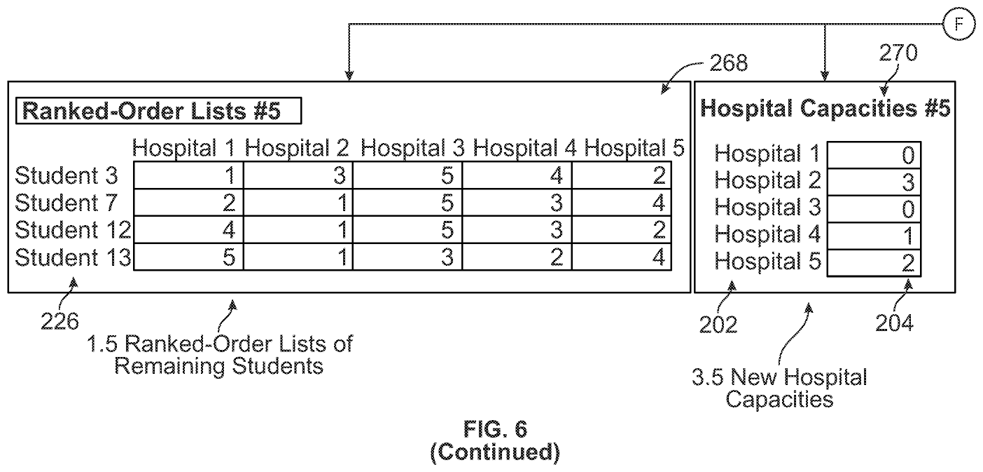

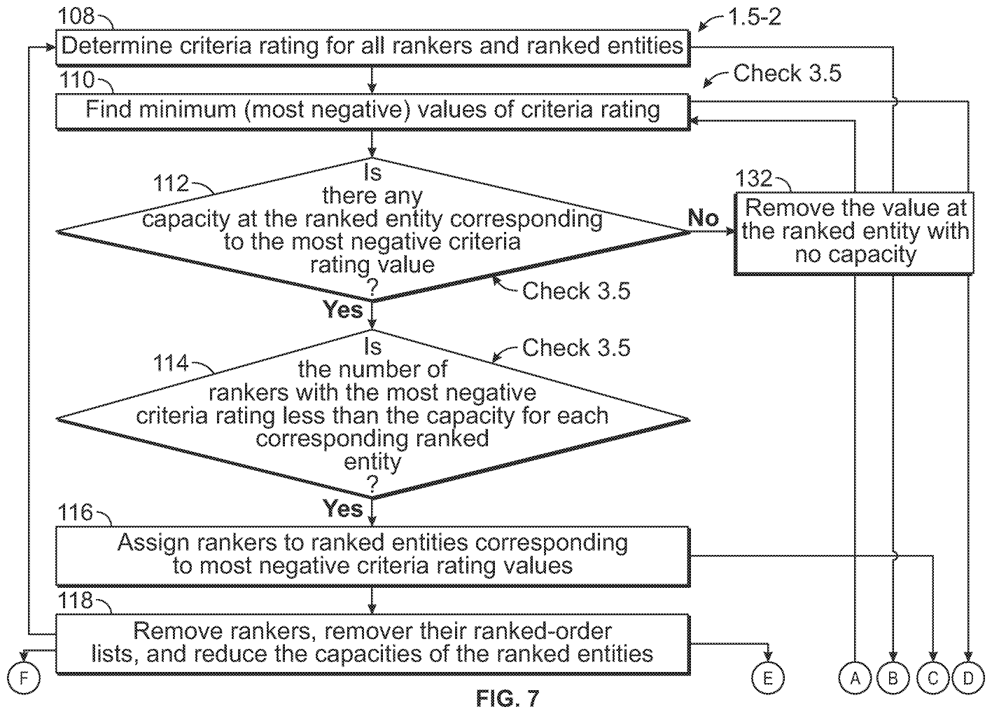

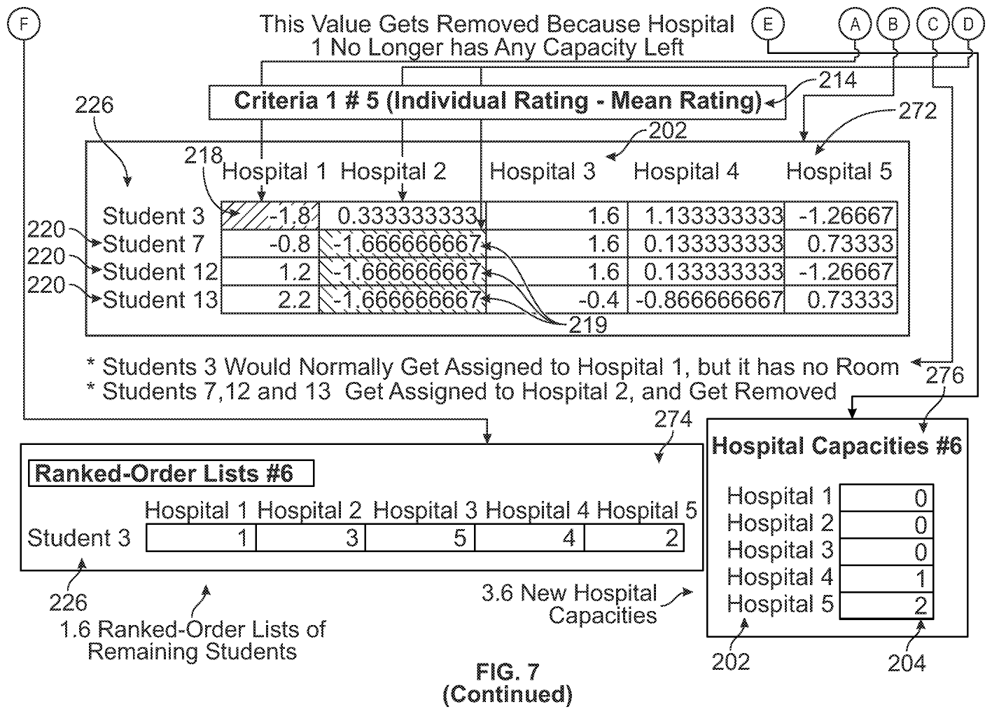

In Step 110, the process or series of Step 110 is repeated again for the remaining rankers 226 by determining or finding the most negative first criteria rating 214 associated for any remaining rankers 226 with any ranked entity 202. As illustrated in FIG. 7, and as shown in box 272, of all the first criteria rating 214 associated with any ranked entity 202 for all of the remaining rankers 226, the most negative criteria rating 214, in this non-limiting example, is “−1.8” which is associated with rankers 226 (e.g., Student 3) and with ranked entity 202 (e.g., Hospital 1). Once completed, proceed back to Step 112.

In Step 112, the process or series of Step 112 is repeated again to determine if there is any capacity 204, or remaining capacity 204, at the most negative ranked entities 218. Based on the previous Step 110, and in the non-limiting example, the current most negative ranked entities 218 is “Hospital 1.” Referring back to FIG. 6, as shown in box 270, the total capacity 204, or remaining capacity 204, for this ranked entity 202 (e.g., Hospital 1) is “0”. If the determination is that there is capacity 204, or remaining capacity 204, at any of the most negative ranked entities 202, then proceed to Step 114. However, if the determination is that there is no (e.g., or zero) capacity 204, or remaining capacity 204, at any of the current most negative ranked entities 218, such as here where this ranked entity 202 (e.g., Hospital 1) has “0” capacity 204, or remaining capacity 204, then proceed to Step 132.

In Step 132, remove the lost first negative criteria rating 214 associated for any remaining rankers 226 with any ranked entity 202 having zero (e.g., 0) capacity 204, or remaining capacity 204, from consideration, then proceed back to Step 110.

In Step 110, determine the next (or succeeding) most negative first criteria rating 214 associated for any remaining rankers 226 with any ranked entity 202. As illustrated in FIG. 7, and as shown in box 272, of all the next (or succeeding) most negative first criteria rating 214 associated with any ranked entity 202 for all of the remaining, rankers 226, the next (or succeeding) most negative first criteria rating 219, in this non-limiting example, is “−1.666666667” which is associated with rankers 226 (e.g., Students 7, and 13) and with ranked entity 202 (e.g., Hospital 2). Once completed, proceed hack to Step 112.

In Step 112, the process or series of Step 112 is repeated again to determine if there is any capacity 204, or remaining capacity 204, at the most negative ranked entities 218. Based on the previous Step 110, and in the non-limiting example, as the next (or succeeding) most negative criteria rating 219 is associated with rankers 226 (e.g., Students 7, 12, and 13) and with ranked entity 202 (e.g., Hospital 2), referring back to FIG. 6, as shown in box 270. the total capacity 204, or remaining capacity 204, for this ranked entity 202 (e.g., Hospital 2) is “3”. If the determination is that there is capacity 204, or remaining capacity 204, at any of the most negative ranked entities 202, such as here with this ranked entity 202 (e.g., Hospital 2) having capacity 204, or remaining capacity 204, of “3”, then proceed to back to Step 114.

In Step 114, the process or series of Step 114 is repeated again to determine if the total number of the most negative rankers 226 is equal to or less than the capacity 204, or remaining capacity 204, for each of the ranked entity 202 associated with the next (or succeeding) most negative ranked criteria rating 219. In the non-limiting example, the most negative rankers 220 is “3” (e.g., Students 7, 12, and 13); and the capacity 204, or remaining capacity 204, of the ranked entity 202 associated with the next (or succeeding) most negative ranked criteria rating 219 (e.g., “Hospital 2”) is “3”. In this mariner, as the total number of the most negative rankers 220 (e.g., 3 is equal to or less than the capacity 204 (e.g., 3) for the ranked entity 202 associated with the next (or succeeding) most negative ranked criteria rating 219, proceed back to Step 116.

Repeating Step 116 and continuing with the non-limiting example, the current most negative ranker 220 (e.g., Students 7, 12, and 13) are assigned to the most negative ranked entity 219 (e.g., “Hospital 2”). As the capacity 204, or remaining capacity 204, for “Hospital 2” is “3” and the most negative ranker 220 (e.g., Students 7, 12, and 13) is assigned to “Hospital 2”, this assignment of ranker 220 then takes up all “3” of the capacity 204, or remaining capacity 204, for “Hospital 2”. Once completed, proceed back to Step 118.

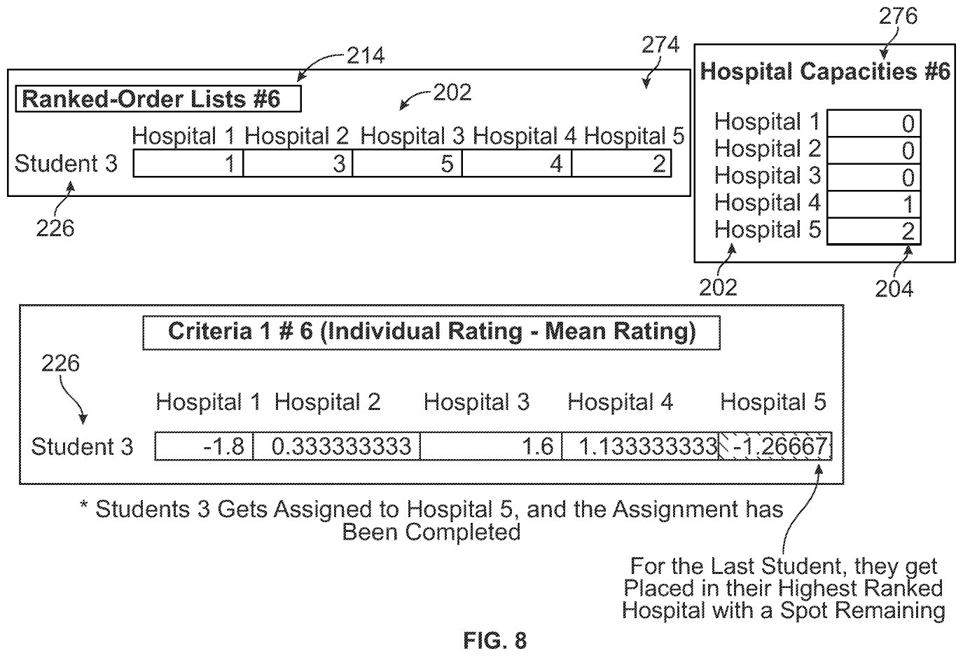

Repeating Step 118 and continuing with the non-limiting example, with the most negative ranker 220 (e.g., Students 12, and 13) being assigned to the most negative ranked entity 219 (e.g., “Hospital 2”) and taking up all “3” of the capacity 204, or remaining capacity 204, for “Hospital 2”, the most negative ranker 220 or “next assigned rankers” and all entries 205 associated with these next assigned rankers 220 e.g., Students 7, 12, and 13) are removed from the rankers list. In this manner, the next assigned ranker 220 (e.g., Students 7, 12, and 13) and all its or their associated entries 205 are removed from FIG. 6, box 268, as now reflected and illustrated in FIGS. 7 and 8, and as shown in the updated box 274, leaving the remaining rankers 226.

Additionally, the capacity 204 to the most negative ranked entities 219 (e.g., “Hospital 2”) is likewise updated to reflect the next assigned rankers. In this manner, the capacity 204 to the most negative ranked entities 219 (e.g., “Hospital 2”) is removed from FIG. 6, box 270, as now reflected and illustrated in FIGS. 7 and 8, and as shown in updated box 276 which shows the capacity 204 for “Hospital 2” as being “0”. Once completed, proceed back to Step 110.

Repeating Step 110, determine the next (or succeeding) most negative first criteria rating 214 associated for any remaining rankers 226 with any ranked entity 202. As illustrated in FIG. 8, and as shown in box 274, of all the next (or succeeding) most negative first criteria rating 214 associated with any ranked entity 202 for all of the remaining rankers 226, there is only one remaining ranker 226 (e.g., Student 3), in which case, the remaining ranker 226 (e.g., Student 3) is assigned their highest ranked entity 202. In the non-limiting example, the remaining ranker 226 (e.g., Student 3) highest ranked entity 202 is (e.g., Hospital 1). As illustrated in FIG. 8, and as shown in box 276, the capacity 204, or remaining capacity 204, for this ranked entity 202 (e.g., Hospital 1) is “0”. Proceeding to the next highest ranked entity 202, the remaining ranker 226 (e.g., Student 3) next highest ranked entity 202 is (e.g., Hospital 5). As illustrated in FIG. 8, and as shown in box 276, the capacity 204, or remaining capacity 204, for this ranked entity 202 (e.g., Hospital 5) is “2”. As the total number of the remaining ranker 226 (e.g., 1 is equal to or less than the capacity 204, or remaining capacity 204, (e.g., 2) for this ranked entity 202, this remaining ranker 226 (e.g., Student 3) is assigned to this ranked entity 202 (e.g., “Hospital 5”). Once completed, proceed to Step 134.

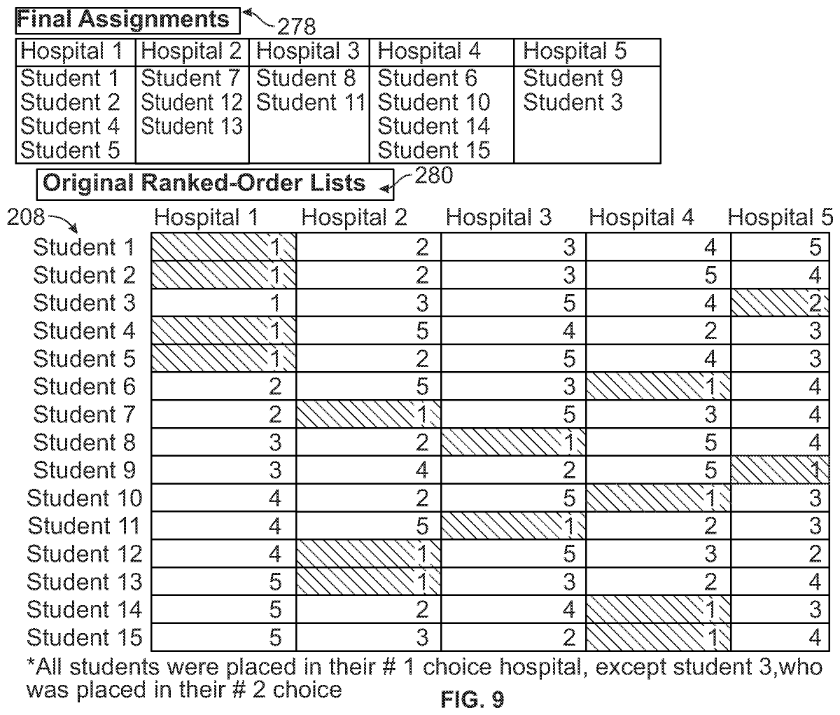

In Step 134, determination of the results of the problem to be solved that there are many potential students that are desirous of their preferred hospitals is provided. In the non-limiting example, as illustrated in FIG. 9, all of the final assignments 278 are provided and, for each ranker 208, the indication 280 of the entry 205 for each ranker 208 is identified, which represents which order of preference the rankers 208 received from their entry 205. In this non-limiting example, all of the rankers 208 received their first preference or choice entry 205 of “1”, except ranker 208 (e.g., Student 3) who was placed in their second preference or choice entry 205 of “2”. Once completed, proceed to Step 136.

In the non-limiting example, referenced in detail throughout as set forth in FIGS. 2 through 9, should there be any errors or omissions in any of the boxes or illustrations, while the specifics of this non-limiting example might be affected, Applicant's invention as shown in the process or series of steps herein (e.g., Steps 100 through 136), remains the same,

In Step 136, Applicant's invention is complete.

Thus, there has been provided a unique method for determining and assigning each ranker from a group into a specific group of ranked entities based upon the ranker's preference. While the invention has been described in conjunction with a specific embodiment, it is evident that many alternatives, modifications and variations will be apparent to those skilled in the art in light of the foregoing description. Accordingly, it is intended to embrace all such alternatives, modifications and variations as fall within the spirit and scope of the appended claims.

1. A method for assigning each ranker from a group to an entity from a plurality of entities, comprising the steps of:
providing a plurality of rankers from the group;
providing a capacity for each of the plurality of entities;
determining a total capacity for all of the plurality of entities;
if the plurality of rankers is equal to or less than the total capacity, performing the following steps:
(a) listing each of the plurality of entities in order of precedence for each of the plurality of rankers;
(b) creating an average rating for each of the plurality of entities;
(c) creating a first criteria rating for each of the plurality of entities corresponding to each of the plurality of rankers;
(d) determining the most negative first criteria rating created for any of the plurality of rankers;
(e) identifying which entities from the plurality of entities are associated with the most negative first criteria rating and creating a most negative ranked entity;
(f) identifying which entities from the plurality of entities are associated with the most negative first criteria rating and creating a plurality of first most negative rankers;
(g) identifying the capacity for the most negative ranked entity;
if the total number of the plurality of first most negative rankers is equal to or less than the capacity for the most negative ranked entity;
(h) assigning each of the plurality of first most negative rankers to the most negative ranked entity and defining each as the assigned rankers.

2. The method of claim 1 and further comprising the step of defining the order of precedence as identifying the most preferential to the least preferential.

3. The method of claim 1 and further comprising the step of defining the most negative first criteria to he the smallest first criteria rating corresponding to any of the plurality of entities.

4. The method of claim 1 and further comprising the step of removing each of the assigned rankers from the plurality of rankers and defining the remaining rankers as the remaining plurality of rankers.

5. The method of claim 1 and further comprising the step of updating the capacity corresponding to the most negative ranked entity.

6. The method of claim 5 and further comprising the step of, if the total number of most negative rankers from the remaining plurality of rankers is greater than the capacity for the most negative ranked entity, arranging the first criteria rating for each of the plurality of entities associated with the most negative rankers from the most negative to the most positive.

7. The method of claim 6 and further comprising the step of creating a second criteria rating for each of the plurality of entities corresponding to each of the most negative rankers.

8. The method of claim 7 and further comprising the step of determining the most negative second criteria rating created for the most negative rankers.

9. The method of claim 8 and further comprising the step of identifying which entities from the plurality of entities are associated with the most negative second criteria rating and creating a second most negative ranked entity.

10. The method of claim 9 and further comprising the step of identifying which entities from the plurality of entities are associated with the most negative second criteria rating and creating a plurality of second most negative rankers.

11. The method of claim 10 and further comprising the step of identifying the capacity for the second most negative ranked entity.

12. The method of claim 11 and further comprising the step of, if the total number of the plurality of second most negative rankers is equal to or less than the capacity for the second most negative ranked entity, assigning each of the plurality of second most negative rankers to the second most negative ranked entity and defining each as the second assigned rankers.

13. A method for assigning each ranker from a group to an entity from a plurality of entities, comprising the steps of:
providing a plurality of rankers from the group;
providing a capacity for each of the plurality of entities;
determining a total capacity for all of the plurality of entities;
if the plurality of rankers is equal to or less than the total capacity, performing the following steps:
(a) determining the most negative first criteria rating created for any of the plurality of rankers;
(b) identifying which entities from the plurality of entities are associated with the most negative first criteria rating and creating a most negative ranked entity;
(c) identifying which entities from the plurality of entities are associated with the most negative first criteria rating and creating a plurality of first most negative rankers;
(d) identifying the capacity for the most negative ranked entity;
if the total number of the plurality of first most negative rankers is equal to or less than the capacity for the most negative ranked entity;
(e) assigning each of the plurality of first most negative rankers to the most negative ranked entity and defining each as the assigned rankers.

14. The method of claim 13 and further compromising the step of creating a first criteria rating for each of the plurality of entities corresponding to each of the plurality of rankers from which to determine the most negative first criteria rating.
